(19) United States
(12) Patent Application Publication
(10) Pub. No.: US 2020/0150905 A1
(43) Pub. Date: May 14, 2020

(54) IMAGE FORMING APPARATUS, CORRECTION IMAGE FORMING METHOD, AND IMAGE FORMING SYSTEM

(71) Applicant: Konica Minolta, Inc., Tokyo (JP)

(72) Inventors: Youichirou NISHI, Tokyo (JP); Hiroyuki ARAI, Tokyo (JP); Shingo SASAMI, Tokyo (JP)

(21) Appl. No.: 16/681,027

(22) Filed: Nov. 12, 2019

(30) Foreign Application Priority Data
Nov. 14, 2018 (JP) 2018-213423

(51) Int. Cl. G06F 3/12

(52) U.S. Cl. CPC G06F 3/121; G06F 3/1242; G06F 3/1234

(57) ABSTRACT

An image forming apparatus includes: a correction content extractor that compares original image data of an original image formed on an image-formed recording material, with corrected original image data of the original image that is corrected, and extracts a correction content of the original image; a correction position extractor that compares the original image data with read image data read from the image-formed recording material, and extracts a correction position of the correction content according to a shape of the image-formed recording material; a correction image data generator that generates correction image data for forming a correction image in accordance with a shape of the image-formed recording material based on the correction content and the correction position; and an image former that forms the correction image at the correction position of the image-formed recording material based on the correction image data.

The present invention claims priority under 35 U.S.C. § 119 to Japanese Patent Application No. 2018-213423, filed on Nov. 14, 2018, is incorporated herein by reference in its entirety.

### BACKGROUND

### Technological Field

The present invention relates to an image forming apparatus, a correction image forming method, and an image forming system.

### Description of the Related Art

Conventionally, image inspection has been performed in which an image printed on a sheet is read by a reading device such as a scanner, and the read image is analyzed to detect an abnormal part of the image. If a print content error has been found after printing, printing has been performed again on another sheet with a correct print content, or an operator has manually corrected the error area of the printed sheet. However, cost is increased in using an expensive sheet, and the manual correction also takes time and effort. Therefore, as a technique for performing correction printing after inputting correction information for read image data of a printed sheet, for example, techniques disclosed in JP H10-290358 A and JP 2010-93528 A have been known.

JP H10-290358 A discloses a technique of, when correcting a document, reading the document with a scanner and inputting overwrite print data and overwrite print position data for the read data generated by the scanner on a personal computer (PC), to perform overwrite print at the overwrite print position on the document.

JP 2010-93528 A discloses a technique of enabling input of a revision area and correction information for an image of a printed sheet read by a scanner part provided on a conveyance path and displayed on a display, overwriting and printing the revision area with the same color toner as the sheet, and then overwriting and printing the revision information in the revision area on the basis of the read image and the inputted revision area and revision information.

JP H10-290358 A and JP 2010-93528 A both disclose a technique for correcting read image data of a printed sheet. Therefore, after reading the printed sheet with a scanner and the like, it is necessary for an operator to input data for overwrite printing on the printed sheet for each side that requires correction, which deteriorates productivity in correcting a plurality of different printed sheets. For example, it has been necessary for the operator to visually check and adjust a correction position for each side, for a plurality of printed sheets with different correction contents and correction positions, which has required a lot of time and effort.

Further, a shape varies for each printed sheet, or the shape is changed by post-processing after the first printing. When modifying image data used at the time of first printing and performing correction printing for such a sheet, there has been a case where the accuracy of the alignment of the correction area is deteriorated, and the correction is performed on an unintended area.

### SUMMARY

The present invention has been made in view of such a situation, and an object of the present invention is to accurately perform correction printing in accordance with a shape of a printed sheet.

To achieve the abovementioned object, according to an aspect of the present invention, an image forming apparatus reflecting one aspect of the present invention comprises: a correction content extractor that compares original image data of an original image formed on an image-formed recording material, with corrected original image data of the original image that is corrected, and extracts a correction content of the original image; a correction position extractor that compares the original image data with read image data read from the image-formed recording material, and extracts a correction position of the correction content according to a shape of the image-formed recording material; a correction image data generator that generates correction image data for forming a correction image in accordance with a shape of the image-formed recording material based on the correction content and the correction position; and an image former that forms the correction image at the correction position of the image-formed recording material based on the correction image data.

### BRIEF DESCRIPTION OF THE DRAWINGS

The problems, configurations, effects other than those described above provided by one or more embodiments of the invention will become more fully understood from the detailed description given hereinbelow and the appended drawings which are given by way of illustration only, and thus are not intended as a definition of the limits of the present invention:

FIG. 1 is a schematic view showing an overall configuration example of an image forming system according to an embodiment of the present invention;

FIG. 2 is a functional block diagram showing an internal configuration example of an image forming system according to an embodiment of the present invention;

FIG. 3 is an explanatory view showing an example of original image data, a printed sheet, and corrected original image data according to an embodiment of the present invention;

FIG. 4 is an explanatory view showing an example of a correction content according to an embodiment of the present invention;

FIG. 5 is an explanatory view showing a positional relationship of an original image at sheet end surface reference of a printed sheet, together with original image data and read image data, according to an embodiment of the present invention;

FIG. 6 is an explanatory view showing a position of corrected original image data according to an embodiment of the present invention;

FIG. 7 is an explanatory view showing an example of original image data, a printed sheet, and corrected original image data according to an embodiment of the present invention;

FIG. 8 is an explanatory view showing an example of a correction content according to an embodiment of the present invention;

FIG. 9 is an explanatory view showing a positional relationship of an original image at sheet end surface reference of a printed sheet, together with original image data and read image data, according to an embodiment of the present invention;

FIG. 10 is an explanatory view showing a position of corrected original image data according to an embodiment of the present invention;

FIG. 11 is a flowchart showing an operation example of an image forming system according to an embodiment of the present invention; and

FIG. 12 is a flowchart showing an operation example of an image forming system according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. In this specification and the drawings, parts having substantially the same function or configuration are denoted by the same reference numerals, and redundant explanations are omitted.

### One Embodiment

<Configuration of Image Forming System>

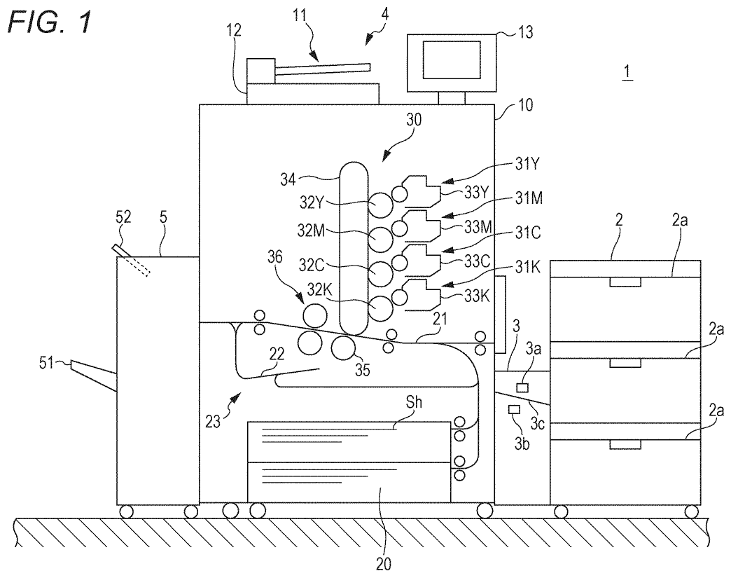

First, a configuration example of an image forming system according to an embodiment of the present invention will be described with reference to FIG. 1.

FIG. 1 is a schematic view showing an overall configuration example of an image forming system 1 according to an embodiment of the present invention. Note that FIG. 1 shows constituents considered necessary for the description of the present invention or related constituents, and the image forming system of the present invention is not limited to the example shown in FIG. 1.

An image forming system 1 according to the present embodiment includes a sheet device 2, a reading device 3, an image forming apparatus 4, and a post-processing device 5.

The sheet device 2 (an example of a sheet feeder) includes a three-stage sheet feeding tray 2a. In the sheet feeding tray 2a, a large amount of sheets are set. The sheets set in the sheet feeding tray 2a are fed to the image forming apparatus 4 via the reading device 3. In the present embodiment, in the sheet feeding tray 2a, in addition to a sheet before printing, a sheet formed with an image by the image forming apparatus 4 and fixed with this image (hereinafter referred to as “printed sheet”) is also set. The printed sheet set in the sheet feeding tray 2a is a sheet required to be formed and fixed with a correction image (referred to as “correction printing”) after printing. A stage of the sheet feeding tray 2a in which printed sheets are set is different from a stage of the sheet feeding tray 2a in which sheets before printing are set. The sheets before printing or the printed sheets set in the sheet feeding tray 2a are fed to the image forming apparatus 4 via the reading device 3.

The reading device 3 discharges the sheet before printing or the printed sheet fed from the sheet device 2, to the image forming apparatus 4. The reading device 3 is provided with a conveyance path 3c through which the sheet before printing or the printed sheet is conveyed. The upstream side of the conveyance path 3c is connected to the sheet device 2, and the downstream side is connected to a conveyance path 21 of the image forming apparatus 4. Here, the reading device 3 discharges the sheet before printing fed from the sheet device 2 to the image forming apparatus 4, without performing any processing.

Whereas, for the printed sheet fed from the sheet device 2 for correction printing, the reading device 3 reads a shape of the printed sheet and an image printed on the printed sheet (referred to as “printed image”), and then discharges the printed sheet to the image forming apparatus 4. Therefore, the reading device 3 is provided with a printed sheet readers 3a and 3b including line sensors and the like, above and below the conveyance path 3c. The printed sheet readers 3a and 3b are provided in a middle of the conveyance path 3c from the sheet device 2 to an image former 30. The printed sheet readers 3a and 3b can individually read a shape and a printed image of a printed sheet conveyed through the conveyance path 3c, and generate reading image data of the printed sheet. However, one of the printed sheet readers 3a and 3b may be provided on one of the upper side or the lower side alone of the conveyance path 3c.

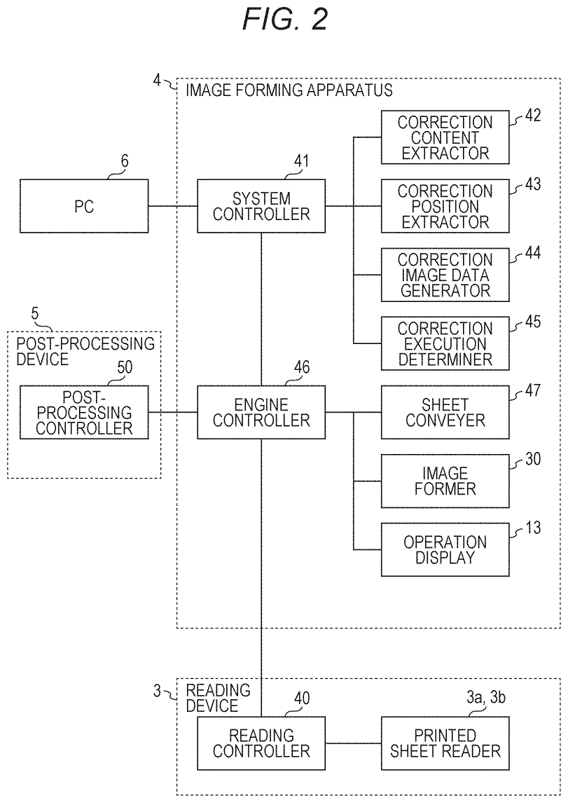

The image forming apparatus 4 is an example of an image forming apparatus that forms an image on a sheet by an electrophotographic system that forms an image using static electricity. For example, the image forming apparatus 4 forms a color image on a sheet in a tandem manner in which toner images of four colors of yellow (Y), magenta (M), cyan (C), and black (K) are superimposed. The image forming apparatus 4 is connected to a PC 6 (see FIG. 2 described later) and the like operated by an operator via a local area network (LAN) not shown. Then, the image forming apparatus 4 performs various processes such as an image forming process, in accordance with a job inputted from the PC 6 via the LAN.

The post-processing device 5 performs post-processing such as cutting processing and punching processing on a printed sheet. The printed sheet that has been successfully post-processed is discharged onto a sheet discharge tray 51. The post-processing device 5 has an online configuration connected to a subsequent stage of the image forming apparatus 4, but may have an offline configuration. In the offline configuration, the post-processing device 5 is disconnected from the image forming apparatus 4. Then, the operator transports the printed sheet discharged onto the sheet discharge tray 51 of the image forming apparatus 4 to the post-processing device 5, and then the post-processing device 5 performs post-processing.

When the operator checks the printed sheet discharged onto the sheet discharge tray 51 of the image forming apparatus 4 and determines that correction printing is necessary, the operator sets the printed sheet in the sheet feeding tray 2a of the sheet device 2. Then, the printed sheet subjected to the correction printing by the image forming apparatus 4 is discharged onto the sheet discharge tray 52. By separating the types of printed sheets and discharging the printed sheets onto the sheet discharge trays 51 and 52 in this way, the operator can easily distinguish whether the discharged printed sheet has been subjected to correction printing.

Here, a detailed internal configuration example of the image forming apparatus 4 will be described.

The image forming apparatus 4 is provided with a sheet feeding tray 20 and a printer 10 having the image former 30, in addition to an image inputter 11 having an auto document feeder (ADF) 12, and an operation display 13.

The image inputter 11 optically reads an image from a document on a document table of the auto document feeder 12, and performs A/D conversion on the read image to generate image data (scan data). Note that the image inputter 11 can also read on platen glass provided on an upper surface of the printer 10.

The operation display 13 includes a display formed by a liquid crystal panel and the like, and an operation part formed by a touch sensor and the like. The display and the operation part are integrally formed as a touch panel, for example. The operation display 13 generates an operation signal representing details of an operation inputted to the operation part from the operator, and supplies the operation signal to an engine controller 46 (see FIG. 2 described later). Further, the operation display 13 displays the details of the operation by the operator, setting information, and the like on the display, on the basis of a display signal supplied from the engine controller 46. Note that the operation part may be formed by a mouse, a tablet, or the like, and may also be formed separately from the display.

The sheet feeding tray 20 is a container that accommodates sheets Sh to be subjected to image formation by the image former 30. The sheet feeding tray 20 individually accommodates the sheets Sh having different sheet types, basis weights, and the like. Although an example is described in which two sheet feeding trays 20 are provided the present embodiment, the number of the sheet feeding trays 20 may be one, or may be three or more.

The image forming apparatus 4 is provided with the conveyance path 21 that conveys the sheet Sh fed from the sheet feeding tray 20 to the post-processing device 5. The conveyance path 21 is provided with a plurality of conveying rollers to convey the sheet Sh.

On downstream of a fixer 36, the conveyance path 21 extends and is connected to a conveyance path (not shown) of the post-processing device 5. Further, the conveyance path 21 is connected with a reverse conveyance path 22 that branches from the downstream side of the fixer 36 and joins the conveyance path 21 on upstream of the printer 10. The reverse conveyance path 22 is provided with an inverter 23 to reverse the sheet Sh. The sheet Sh reversed by the inverter 23 is returned to the upstream side of the conveyance path 21 through the reverse conveyance path 22. In addition, the sheet Sh reversed by switching the path may be returned to the conveyance path 21 on downstream of the fixer 36 and then conveyed to the reading device 3.

The image former 30 includes four image forming units 31Y, 31M, 31C, and 31K to form toner images of respective colors of Y, M, C, and K, and forms an image on the sheet Sh. The image forming units 31Y, 31M, 31C, and 31K are provided with a charger and an exposure (both not shown), photoreceptor drums 32Y, 32M, 32C, and 32K as image carriers, and developers 33Y, 33M, 33C, and 33K, respectively.

The developers 33Y, 33M, 33C, and 33K form an electrostatic latent image on a periphery of each photoreceptor drum by irradiating each surface (outer peripheral part) of the photoreceptor drums 32Y, 32M, 32C, and 32K with light according to the image. Then, the developers 33Y, 33M, 33C, and 33K develop toner images on the photoreceptor drums 32Y, 32M, 32C, and 32K by causing the toner to adhere to the electrostatic latent images.

Further, the image former 30 includes an intermediate transfer belt 34, a secondary transferor 35, and the fixer 36. The intermediate transfer belt 34 is a belt on which images formed on the photoreceptor drums 32Y, 32M, 32C, and 32K are primarily transferred. The secondary transferor 35 is a roller that secondarily transfers the toner images of the individual colors that have been primarily transferred onto the intermediate transfer belt 34, onto the sheet Sh that has been conveyed through the conveyance path 21.

The fixer 36 is disposed downstream of the secondary transferor 35 in a sheet conveyance direction, and applies a fixing process on the sheet Sh formed with the color toner image supplied from the image former 30. The fixer 36 fixes the image transferred by the image former 30 on a front surface side of the sheet Sh, by heating and pressurizing the conveyed sheet Sh. By fixing the image formed on the sheet in this way, printing is completed.

The sheet Sh fixed with the image by the fixer 36 is conveyed to the post-processing device 5 through the conveyance path 21, or returned to the conveyance path 21 on upstream of the printer 10 after the front and back are reversed by the inverter 23 through the reverse conveyance path 22. The printer 10 forms an image on a back surface of the sheet Sh with the front and back reversed. Thereafter, the sheet Sh subjected to the image fixing process by the fixer 36 is conveyed to the post-processing device 5.

FIG. 2 is a functional block diagram showing an internal configuration example of the image forming system 1.

The reading device 3 includes a reading controller 40 in addition to the printed sheet readers 3a and 3b shown in FIG. 1.

Read image data including a shape and a printed image of the printed sheet read by the printed sheet readers 3a and 3b is outputted to the reading controller 40.

The reading controller 40 controls the operation of the printed sheet readers 3a and 3b, and transmits the read image data inputted from the printed sheet readers 3a and 3b to the image forming apparatus 4.

The image forming apparatus 4 includes a system controller 41, a correction content extractor 42, a correction position extractor 43, a correction image data generator 44, a correction execution determiner 45, the engine controller 46, a sheet conveyer 47, the image former 30, and an operation display 13.

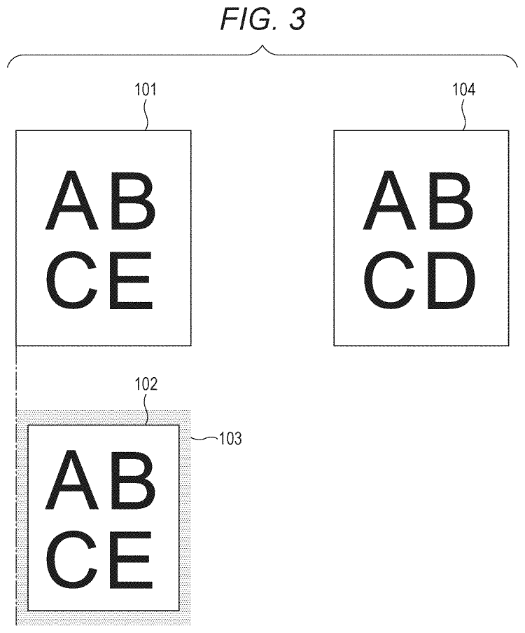

The system controller 41 is a processor that performs control for performing correction printing according to the present embodiment, and is connected with the PC 6 operated by the operator, via a network such as a LAN. The system controller 41 receives a normal printing instruction, original image data for normal printing, a correction printing instruction, corrected original image data, and the like transmitted from the PC 6 to the image forming apparatus 4. Details of the original image data, the corrected original image data, and the like will be described later with reference to FIG. 3 and subsequent figures.

Further, the system controller 41 receives read image data from the reading device 3 via the engine controller 46. Then, the system controller 41 outputs the original image data, the read image data, corrected original image data, and the like to the correction content extractor 42, the correction position extractor 43, the correction image data generator 44, and the correction execution determiner 45.

The correction content extractor 42 compares original image data of an original image before correction formed on the printed sheet, with corrected original image data of the original image corrected by the operator, to extract a correction content of the original image. The correction content is, for example, a content such as correcting a specific character included in the original image to another character. The correction content extracted by the correction content extractor 42 is sent to the system controller 41.

The correction position extractor 43 compares original image data with read image data read by the printed sheet readers 3a and 3b from the printed sheet, to extract a correction position of the correction content according to a shape of the printed sheet. The correction position is, for example, a parameter for aligning the correction content in accordance with the printed sheet, in a case where a position specified by the correction content is changed from a position of a sheet before cutting due to a change of the sheet size by cutting of the printed sheet. The correction position extracted by the correction position extractor 43 is sent to the system controller 41.

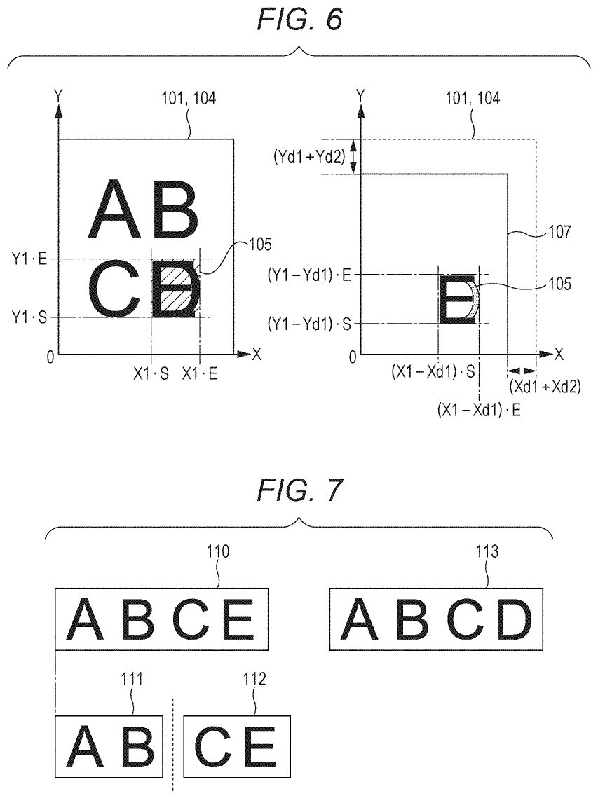

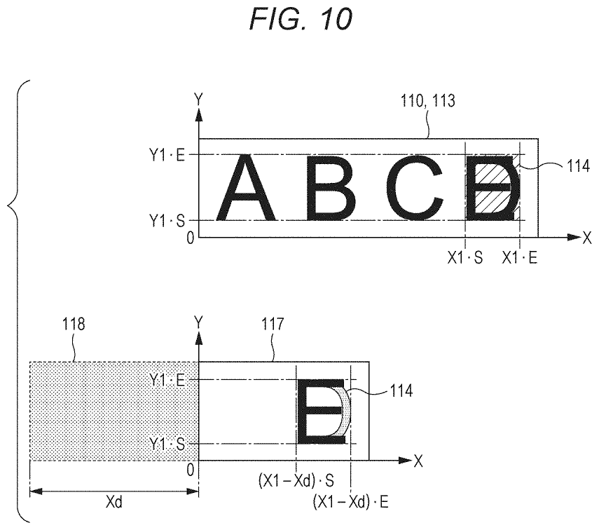

Here, the correction position extractor 43 extracts the correction position as a relative position with respect to the shape of the printed sheet. Specifically, as shown in FIG. 6 and FIG. 10 described later, the correction position extractor 43 extracts the correction position on the basis of coordinates with an end face of the printed sheet as a reference.

On the basis of the extracted correction content and correction position, the correction image data generator 44 generates correction image data for forming a correction image in accordance with the shape of the printed sheet. Here, the correction image data generated by the correction image data generator 44 includes a correction image in which, in an original image formed on the printed sheet, an area other than a correction content in a correction region including the correction content is overwritten by the image former 30 with the same color as the background color of the printed sheet. Note that there may be generated correction image data including a correction image in which the image former 30 overwrites an area other than the correction content in the correction region, with a base color of the printed sheet. The correction content and the correction position are sent from the system controller 41 to the correction image data. If the correction content and the correction positions of the original images formed on a plurality of printed sheets are the same, correction image data is generated once, which is to be a correction image that can be formed in common on the plurality of printed sheets.

The correction execution determiner 45 determines whether or not correction image formation (correction printing) can be performed on a printed sheet. When the original image data and the read image data are the same, the correction execution determiner 45 determines that correction image formation can be performed on the printed sheet for which the read image data is generated, and causes the image former 30 to perform correction printing on the printed sheet. The correction printing execution instruction determined by the correction execution determiner 45 is sent to the system controller 41, and then sent from the system controller 41 to the image former 30 via the engine controller 46. The image former 30 instructed to execute the correction printing forms a correction image at the correction position of the printed sheet on the basis of the correction image data.

In addition, the correction execution determiner 45 determines whether or not a correction content is included in the read image data that is generated by the printed sheet readers 3a and 3b reading the front surface or the back surface of the printed sheet with images formed on both sides on the basis of the original image data. Then, the correction execution determiner 45 determines that the correction image formation is permitted on a surface including the correction content. Further, the correction execution determiner 45 determines that the correction image formation is not permitted on a surface not including the correction content. In this case, a correction printing execution instruction is performed on the surface determined to be permitted by the correction execution determiner 45, and correction printing by the image former 30 is performed on this surface.

Moreover, when the original image data and the read image data are different, the correction execution determiner 45 determines that correction image formation is not permitted on the printed sheet for which the read image data is generated, and the printed sheet for which the read image data is generated is discharged as it is. In addition, also when the correction content is not included in the read image data, the correction execution determiner 45 determines that the correction image formation is not permitted, and the printed sheet for which the read image data is generated is discharged as it is. At this time, no correction image is formed on the discharged the printed sheet.

The engine controller 46 controls operations of the operation display 13, the image former 30, and the sheet conveyer 47. As described above, the engine controller 46 outputs a display signal to the operation display 13, to display an operation screen. Further, the engine controller 46 controls the operation of the image forming apparatus 4 on the basis of the operation signal inputted from the operation display 13.

In addition to the printing process for forming an image on the sheet Sh as described above, the image former 30 can perform correction printing for forming an image on a printed sheet. Then, the image former 30 forms a correction image for each printed sheet. Therefore, after the printed sheet is read by the printed sheet readers 3a and 3b, and the correction image data is generated by the correction image data generator 44, the printed sheet is conveyed to the image former 30 and formed with a correction image based on the correction image data.

The sheet conveyer 47 controls, for example, the conveying rollers provided in the conveyance path 21, the reverse conveyance path 22, and the like shown in FIG. 1, to control the conveyance direction of the sheet Sh or the printed sheet. During the correction printing, the sheet conveyer 47 can cause the printed sheet to wait before the image former 30, and restart the conveyance of the printed sheet and cause the image former 30 to form a correction image on the printed sheet when it is determined that the execution of correction printing by the correction execution determiner 45 is permitted. A place where the printed sheet waits is desirably before the image former 30, for example, before a registration roller that corrects skew feeding of the sheet Sh or the printed sheet.

The post-processing device 5 includes a post-processing controller 50.

The post-processing controller 50 controls operations of various devices (punch, cutter) and the like necessary for post-processing. The post-processing controller 50 performs control to discharge the sheet Sh subjected to normal printing onto the sheet discharge tray 51, and to discharge the printed sheet subjected to correction printing onto the sheet discharge tray 52.

Next, an example of performing correction printing on a printed sheet that has been cut in four directions will be described with reference to FIG. 3 to FIG. 6.

FIG. 3 is an explanatory view showing an example of original image data 101, a printed sheet 102, and corrected original image data 104.

The upper left of FIG. 3 shows an example of the original image data 101 in which characters “AB” are arranged in the first line and characters “CE” are arranged in the second line. The original image data 101 is image data before correction in the present embodiment.

The lower left of FIG. 3 shows an example of the printed sheet 102 formed with an image on the basis of the original image data 101. FIG. 3 shows a state where a left end face of the printed sheet 102 before cutting and a left end face of the original image data 101 are aligned with a one dotted chain line. The printed sheet 102 formed with an image by the image forming apparatus 4 is the sheet Sh that has been cut in four directions by the post-processing device 5. Therefore, a cutting area 103 is shown on all sides of the printed sheet 102. Since the cutting area 103 is a part to be discarded, the size of the printed sheet 102 is entirely smaller than the size of the sheet Sh before printing.

The upper right of FIG. 3 shows an example of the corrected original image data 104 in which characters “AB” are arranged in the first line and characters “CD” are arranged in the second line. In the present embodiment, the character “E” included in the original image data 101 is corrected to the character “D” in the corrected original image data 104. The work of correcting the original image data 101 to create the corrected original image data 104 is performed by an operator who operates the PC 6, for example. Sizes of the original image data 101 and the corrected original image data 104 are the same.

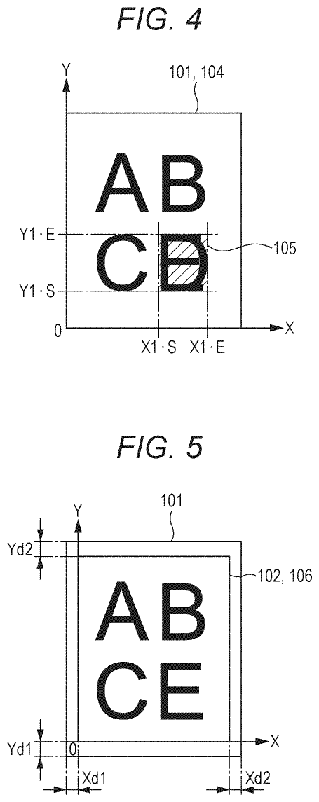

FIG. 4 is an explanatory view showing an example of a correction content. FIG. 4 shows a state where the original image data 101 and the corrected original image data 104 shown in FIG. 3 are superimposed.

When correction printing is performed on the printed sheet 102, the printed sheet 102 is set in the sheet feeding tray 2a of the sheet device 2. Then, the corrected original image data 104 is inputted from the PC 6 to the image forming apparatus 4. The correction content extractor 42 of the image forming apparatus 4 compares the original image data 101 with the inputted corrected original image data 104, and extracts a correction content indicating that the character “E” is corrected to the character “D”. An area where the minimum correction including the correction content is performed is represented as a correction region 105 in the drawing.

FIG. 4 shows an example in which a lower left corner of the original image data 101 and the corrected original image data 104 is an origin 0, and a position of the correction region 105 is expressed by an X coordinate and a Y coordinate. Here, paying attention to the character “E” to be corrected in the original image data 101, the correction region 105 of the character “E” is a rectangular area indicated by hatching with X1·S (Start) as a start point and X1·E (End) as an end point in the X direction, and Y1·S as a start point and Y1·E as an end point in the Y direction. In the correction region 105, the corrected character “D” is shown to be superimposed on the original character “E”.

FIG. 5 is an explanatory view showing a positional relationship of the original image at sheet end surface reference of the printed sheet 102, together with the original image data 101 and read image data 106.

After the correction content shown in the correction region 105 is extracted, the printed sheet 102 set in the sheet feeding tray 2a is fed from the sheet device 2 to the reading device 3. The printed sheet readers 3a and 3b of the reading device 3 read a shape and a printed image of the printed sheet 102, and generate the read image data 106. Thereafter, the printed sheet 102 is made to wait at a standby position before the image former 30. Further, the correction position extractor 43 compares the shape and the printed image of the read image data 106 read and generated by the reading device 3 with the original image data 101, to determine a positional relationship of the printed image at sheet end surface reference of the printed sheet 102.

The printed sheet 102 is slightly smaller than the sheet before printing because the printed sheet 102 is obtained by cutting the sheet printed with the original image data 101 in four directions, as described above. Therefore, the size of the read image data 106 of the printed sheet 102 is also slightly smaller than the size of the original image data 101. As shown in FIG. 5, when characters “ABCE” included in the original image data 101 and characters “ABCE” included in the read image data 106 are superimposed with a lower left corner of the read image data 106 as the origin of the XY coordinates, the cutting area is determined. A length of the read image data 106 in the X-axis direction is shorter than that of the original image data 101 by a width Xd1 at a left end and by a width Xd2 at a right end, and a length in the Y-axis direction is shorter than that of the original image data 101 by a width Yd1 at a lower end and by a width Yd2 at an upper end.

FIG. 6 is an explanatory view showing an example of the original image data 101, the corrected original image data 104, and correction image data 107.

The correction image data generator 44 generates the correction image data 107 according to a shape of the printed sheet 102, on the basis of a positional relationship between the original image data 101 and the corrected original image data 104 shown in FIG. 5.

The left side of FIG. 6 shows an example of the correction region 105 obtained by superimposing the original image data 101 and the corrected original image data 104, as in the explanatory view of FIG. 4. The right side of FIG. 6 shows an example of the correction image data 107 generated by the correction image data generator 44. The correction image data 107 has a size shorter than the corrected original image data 104 by a width Xd1+Xd2 in the X direction and a width Yd1+Yd2 in the Y direction. A position of the corrected character “E” is moved in accordance with a shape of an actual printed sheet 102 obtained from the read image data 106 shown in FIG. 5. For example, the position of the corrected character “E” is a position moved by a width Xd1 toward the origin side in the X direction and moved by a width Yd1 toward the origin side in the Y direction.

Further, the correction region 105 represents an area where an erased area of the printed image is overwritten with the background color of the printed sheet 112. Here, the character “E” is overwritten on the character “D” printed on the printed sheet 102. Further, an area other than the character “E” in the correction region 105 is overwritten with the same color as the background color of the printed sheet 102.

After the correction image data generator 44 generates the correction image data 107 in this way, the correction execution determiner 45 determines whether or not to permit correction printing. Then, when execution of correction printing is instructed, the correction image data 107 is outputted to the image former 30, and the conveyance of the printed sheet 102 that has been waiting before the image former 30 is restarted. The printed sheet 102 conveyed to the image former 30 is subjected to correction printing based on the correction image data 107, by the image former 30. Then, the printed sheet 102 subjected to the correction printing is discharged through the post-processing device 5.

Meanwhile, if the operator accidentally switches the order of the printed sheets 102 when setting the printed sheets 102 in the sheet feeding tray 2a, it is conceivable that the order of the correction image data 107 and the order of the printed sheets 102 do not match. Preparing for such a case, the correction execution determiner 45 determines not to permit execution of the correction printing when the image printed on the printed sheet 102 read by the reading device 3 is different from the image indicated by the original image data 101. In this case, since the correction printing is interrupted, the printed sheet 102 is discharged without being subjected to the correction printing.

Further, in the present embodiment, an example is shown in which correction printing is performed on the printed sheet 102 with an image printed on one side. However, in a case where an image on the printed sheet 102 with images printed on both sides is corrected, control for performing correction printing with duplex printing is performed. However, even in a case of the printed sheet 102 subjected to duplex printing, if one side alone of the front surface or the back surface is to be subjected to correction printing, the correction printing is performed exclusively on one side.

Next, an example of performing correction printing on a printed sheet that has been divided and cut will be described with reference to FIG. 7 to FIG. 10.

FIG. 7 is an explanatory view showing an example of the original image data 110, printed sheets 111 and 112, and the corrected original image data 113.

The upper left of FIG. 7 shows an example of the original image data 110 in which characters “ABCE” are arranged in one line. The original image data 110 is image data before correction in the present embodiment.

The lower left of FIG. 7 shows an example of the printed sheets 111 and 112 formed with an image on the basis of the original image data 110. FIG. 7 shows a state where a left end face of the printed sheet 111 before cutting and a left end face of the original image data 110 are aligned with a one dotted chain line. The printed sheets 111 and 112 are obtained by dividing and cutting, with the post-processing device 5, one printed sheet formed with an image by the image forming apparatus 4 on the basis of the original image data 110, between the characters “AB” and “CE”.

The upper right of FIG. 7 shows an example of the corrected original image data 113 in which characters “ABCD” are arranged in one line. In the present embodiment, the character “E” included in the original image data 110 is corrected to the character “D” in the corrected original image data 113. The work of correcting the original image data 110 to create the corrected original image data 113 is performed by an operator who operates the PC 6, for example. Sizes of the original image data 110 and the corrected original image data 113 are the same.

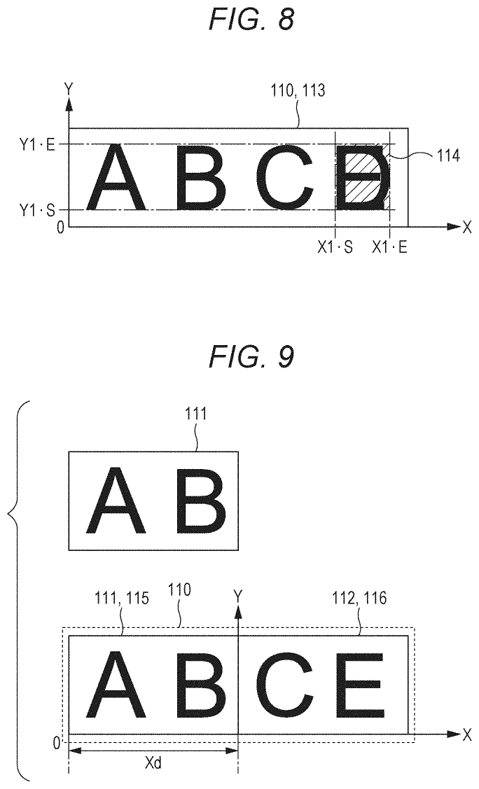

FIG. 8 is an explanatory view showing an example of a correction content. FIG. 8 shows a state where the original image data 110 and the corrected original image data 113 shown in FIG. 7 are superimposed.

In the correction printing, when a printed sheet is divided into the printed sheets 111 and 112, all the printed sheets 111 and 112 are set in the sheet feeding tray 2a of the sheet device 2 regardless of whether correction has been made or not. Here, after the correction printing is performed exclusively on the set printed sheet 112, the operator is required to perform complicated work such as matching page numbers or aligning directions of the printed sheet 111 that has not been set and the printed sheet 112 subjected to correction printing. Therefore, setting all the printed sheets 111 and 112 in the sheet feeding tray 2a eliminates extra work by the operator after the correction printing.

Then, the corrected original image data 113 is inputted from the PC 6 to the image forming apparatus 4. The correction content extractor 42 of the image forming apparatus 4 compares the original image data 110 with the inputted corrected original image data 113, and extracts a correction content indicating that the character “E” is corrected to the character “D”. An area where the minimum correction including the correction content is performed is represented as a correction region 114 in the drawing.

FIG. 8 shows an example in which a lower left corner of the original image data 110 and the corrected original image data 113 is an origin 0, and a position of the correction region 114 is expressed by an X coordinate and a Y coordinate. Here, paying attention to the character “E” to be corrected in the original image data 110, the correction region 114 of the character “E” is a rectangular area indicated by hatching with X1·S (Start) as a start point and X1·E (End) as an end point in the X direction, and Y1·S as a start point and Y1·E as an end point in the Y direction. In the correction region 114, the corrected character “D” is shown to be superimposed on the original character “E”.

FIG. 9 is an explanatory view showing a positional relationship of the original image at sheet end surface reference of the printed sheet 112, together with the original image data 110 and read image data 115 and 116. FIG. 9 shows a position of the corrected original image data with respect to the printed sheet 112. The upper side of FIG. 9 shows the printed sheet 111 printed with characters “AB”, and the lower side of FIG. 9 shows an example of the original image data 110 surrounded by a broken line, and the read image data 115 and 116.

After the correction content shown in the correction region 114 is extracted, when the printed sheet 112 set in the sheet feeding tray 2a is fed from the sheet device 2 to the reading device 3, the printed sheet readers 3a and 3b of the reading device 3 read a shape and a printed image of the printed sheets 111 and 112, and generate the read image data 115 and 116.

The printed sheet 112 printed with characters “CE” includes the correction region 114 shown in FIG. 8. Therefore, in the original image data 110 indicated by the broken line, it is necessary to exclude a part having the width Xd in the X-axis direction including the characters “AB”, from the correction target.

The printed sheets 111 and 112 to be subjected to correction printing are made to wait at a standby position before the image former 30. Further, the correction position extractor 43 compares the shape and the printed image of the read image data 115 and 116 read and generated by the reading device 3 with the original image data 110, to determine a positional relationship of the printed image at sheet end surface reference of the printed sheet 111 and 112. Here, since the printed sheets 111 and 112 are formed with an image obtained by dividing the original image of the original image data 110, the shape and the printed image as they are do not match those of the original image data 110. Therefore, the shape and the printed image of the original image data including the image obtained by dividing the original image of the original image data 110 are compared with those of the read image data of the printed sheets 111 and 112, and a positional relationship of the printed images on the printed sheets 111 and 112 is determined. Then, the printed sheet 112 printed with the characters “CE” includes the correction region 114, and thus is a target for correction printing. Whereas, the printed sheet 111 printed with the characters “AB” does not include the correction region 114, and thus is not a target for correction printing. The printed sheet 111 that is not a target for correction printing is discharged without image formation by the image former 30.

FIG. 10 is an explanatory view showing an example of the original image data 110, the corrected original image data 113, and correction image data 117.

The correction image data generator 44 generates the correction image data 117 according to a shape of the printed sheet 112, on the basis of a positional relationship between the original image data 110 and the corrected original image data 113 shown in FIG. 9.

The upper side of FIG. 10 shows an example of the correction region 114 obtained by superimposing the original image data 110 and the corrected original image data 113, as in the explanatory view of FIG. 8. The lower side of FIG. 10 shows an example of the correction image data 117 generated by the correction image data generator 44. The correction image data 117 has a size shorter than the corrected original image data 113 by the width Xd in the X direction. A position of the corrected character “E” is moved in accordance with a shape of an actual printed sheet 112 obtained from the read image data 116 shown in FIG. 9. For example, the position of the corrected character “E” is a position moved by the width Xd toward the origin side in the X direction.

Further, the correction region 114 represents an area where an erased area of the printed image is overwritten with the background color of the printed sheet 112. Here, the character “E” is overwritten on the character “D” printed on the printed sheet 112. Further, an area other than the character “E” in the correction region 114 is overwritten with the same color as the background color of the printed sheet 112.

Correction of the printed sheet 111 is not necessary. Therefore, the correction image data 117 is obtained by discarding a part 118 of the characters “AB” on the left side of the Y axis, from the corrected original image data 113.

After the correction image data generator 44 generates the correction image data 117 in this way, the correction execution determiner 45 determines a start of execution of correction printing on the printed sheet 112. Then, the correction image data 117 is outputted to the image former 30, and the conveyance of the printed sheet 112 that has been waiting before the image former 30 is restarted. The printed sheet 111 that is not the target of the correction printing is discharged from the image forming apparatus 4 without any processing. Whereas, the printed sheet 112 that is the target of the correction printing is subjected to the correction printing based on the correction image data 117 by the image former 30. Then, the printed sheet 112 subjected to the correction printing is discharged through the post-processing device 5.

Next, an operation example of the image forming system 1 according to the present embodiment will be described.

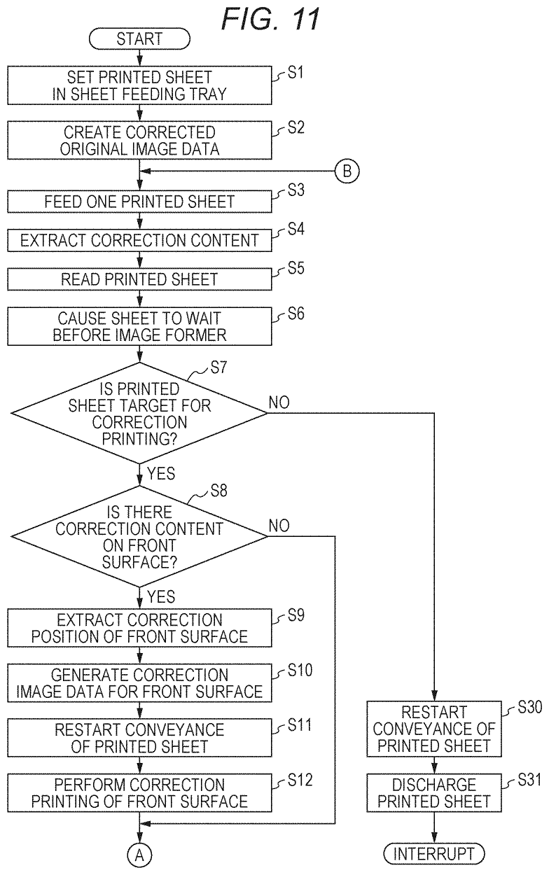

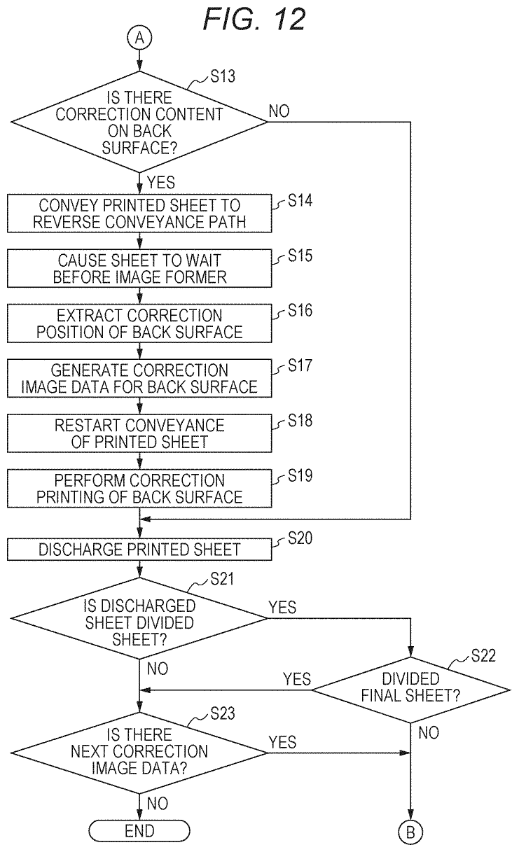

FIG. 11 and FIG. 12 are flowcharts showing an operation example of the image forming system 1.

As a premise of this processing, it is assumed that a printed sheet formed with an image by the image forming apparatus 4 is subjected to post-processing by the post-processing device 5, and then discharged onto the sheet discharge tray 51. Then, the operator performs a visual inspection on the printed sheet taken out from the sheet discharge tray 51. After determination that correction printing is necessary, this processing is started.

First, the operator sets printed sheets in the sheet feeding tray 2a of the sheet device 2 in the order in which they are outputted onto the sheet discharge tray 51 (S1). Next, the operator operates the PC 6 to create corrected original image data on the basis of the original image data (S2). Then, the operator instructs the image forming apparatus 4 to execute correction printing. At this time, the corrected original image data is transmitted to the image forming apparatus 4.

In processing of the correction printing, first, the sheet device 2 feeds one printed sheet to the reading device 3 (S3). Next, the correction content extractor 42 compares the corrected original image data received by the system controller 41 from the PC 6 with the original image data received from the PC 6 in advance, and extracts a correction content (S4). If correction is necessary on the image printed on both sides of the printed sheet, the corrected original image data for both sides and the original image data are compared, and the correction content for both sides is extracted.

Next, the printed sheet readers 3a and 3b of the reading device 3 installed before the image former 30 read the printed sheet (S5), and output the read image data to the reading controller 40. In the present embodiment, the printed sheet readers 3a and 3b output the read image data of both sides of the printed sheet. However, in a case of a printed sheet on which one side alone is printed, read image data of one side is outputted. The reading controller 40 transmits the inputted read image data to the image forming apparatus 4. The image forming apparatus 4 outputs the read image data received by the engine controller 46, to the system controller 41.

Next, the printed sheet fed from the reading device 3 to the image forming apparatus 4 is made to wait before the image former 30 by the function of the sheet conveyer 47 controlled by the engine controller 46 (S6). Next, the correction content extractor 42 compares the read image data extracted from the read image data with the original image data, and determines whether or not the printed sheet waiting before the image former 30 is a target for correction printing (S7).

When the correction content extractor 42 determines that the printed sheet is not a target for correction printing (NO in S7), the determination result is transmitted to the system controller 41. Then, under the control of the engine controller 46, the sheet conveyer 47 drives a conveying roller (not shown), conveyance of the printed sheet is restarted (S30), the printed sheet is discharged from the post-processing device 5 onto the sheet discharge tray 51 (S31), and then this print processing is interrupted. However, after step S31, the process may return to step S3 again to restart feeding of another printed sheet.

When the correction content extractor 42 determines that the printed sheet is a target for correction printing (YES in S7), the determination result is transmitted to the system controller 41. Then, in response to an instruction from the system controller 41, the correction content extractor 42 determines whether or not there is a correction content on a front surface of the printed sheet (S8).

When the correction content extractor 42 determines that there is no correction content on the front surface of the printed sheet (NO in S8), the process proceeds to step S13 connected by a connector A in FIG. 12. Whereas, when the correction content extractor 42 determines that there is a correction content on the front surface of the printed sheet (YES in S8), the correction content extractor 42 extracts the correction content. Thereafter, the correction position extractor 43 compares the read image data of the front surface of the printed sheet with the original image data, and extracts a correction position (S9). Then, the correction position extractor 43 outputs the extracted correction position to the system controller 41, and the system controller 41 outputs the correction position of the front surface of the printed sheet to the correction image data generator 44.

Next, on the basis of coordinates at sheet end surface reference and the correction position of the front surface, the correction image data generator 44 generates correction image data for correcting the front surface of the printed sheet (S10). The correction image data includes a correction image in which the correction content and the correction position are adjusted to the size of the printed sheet. Further, the correction image data generator 44 generates correction image data for overwriting an area other than the correction content included in the correction region with the background color, in the image printed on the front surface of the printed sheet.

Then, the correction image data generator 44 outputs the generated correction image data for the front surface to the system controller 41, and the system controller 41 outputs the correction image data for the front surface to the engine controller 46. The engine controller 46 outputs the correction image data for the front surface to the image former 30.

Thereafter, under the control of the engine controller 46, the sheet conveyer 47 drives a conveying roller (not shown), which restarts the conveyance of the printed sheet (S11). Then, the printed sheet that has been waiting moves to the image former 30, and the image former 30 performs correction printing of forming an image on the front surface of the printed sheet and fixing the image (S12).

Next, in step S13 connected by the connector A in FIG. 12, in response to an instruction from the system controller 41, the correction content extractor 42 determines whether or not there is a correction content on a back surface of the printed sheet (S13).

When the correction content extractor 42 determines that there is no correction content on the back surface of the printed sheet (NO in S13), the process proceeds to step S20. Whereas, when the correction content extractor 42 determines that there is a correction content on the back surface of the printed sheet (YES in S13), the correction content extractor 42 extracts the correction content. Thereafter, an inversion instruction is outputted from the correction content extractor 42 to the system controller 41. The system controller 41 transfers the reverse instruction to the engine controller 46. The engine controller 46 drives the sheet conveyer 47 to convey the printed sheet to the reverse conveyance path 22 (S14). As a result, after the printed sheet is reversed, the sheet conveyer 47 waits again before the image former 30 (S15).

Next, the correction position extractor 43 compares the read image data of the back surface of the printed sheet with the original image data, and extracts a correction position (S16). Then, the correction position extractor 43 outputs the extracted correction position to the system controller 41, and the system controller 41 outputs the correction position of the back surface to the correction image data generator 44.

Next, on the basis of coordinates at sheet end surface reference and the correction position of the back surface, the correction image data generator 44 generates correction image data for correcting the back surface of the printed sheet (S17). At this time, the correction image data generator 44 generates correction image data for overwriting an area other than the correction content included in the correction region with the background color, in the image printed on the back surface of the printed sheet.

Then, the correction image data generator 44 outputs the generated correction image data for the back surface to the system controller 41, and the system controller 41 outputs the correction image data for the back surface to the engine controller 46. The engine controller 46 outputs the correction image data for the back surface to the image former 30.

Thereafter, the sheet conveyer 47 drives under the control of the engine controller 46, which restarts the conveyance of the printed sheet (S18). Then, the printed sheet that has been waiting moves to the image former 30, and the image former 30 performs correction printing of forming an image on the back surface of the printed sheet and fixing the image (S19).

Next, the printed sheet on which the correction printing has been performed on one side of the front surface or the back surface or both sides is discharged from the image forming apparatus 4 to the post-processing device 5 (S20). At this time, straight sheet discharge or reverse sheet discharge is switched such that the discharged surfaces are matched. The straight sheet discharge is a process of discharging a printed sheet as it is that has passed through the image former 30 to the post-processing device 5. The reverse sheet discharge is a process of moving a printed sheet that has passed through the image former 30 to the reverse conveyance path 22, and reversing to discharge to the post-processing device 5. The printed sheet that has passed through the post-processing device 5 is discharged, for example, to the sheet discharge tray 52 that is different from the sheet discharge tray 51 onto which a printed sheet in normal printing is discharged.

Next, the correction execution determiner 45 determines whether or not the discharged printed sheet is a divided printed sheet (described as “divided sheet” in the drawing) (S21). When it is determined as a divided printed sheet (YES in S21), the correction execution determiner 45 determines whether or not the divided printed sheet is a final sheet (described as “divided final sheet” in the drawing) (S22). When it is determined as not the final sheet (NO in S22), the divided printed sheet remains, and thus the process proceeds to step S3 indicated by a connector B in FIG. 11, and the feeding process of the divided printed sheet is continued.

Whereas, when it is determined that the discharged printed sheet is not a divided printed sheet (NO in S21), or when it is determined as a divided printed sheet and also as a fmal sheet (YES in S22), the correction execution determiner 45 determines whether or not there is next correction image data (S23). When there is next correction image data (YES in S23), the process proceeds to step S3 indicated by the connector B in FIG. 11, and the process is continued. When there is no next correction image data (NO in S23), the correction printing process is ended.

In the image forming system 1 according to the embodiment described above, on the basis of the corrected original image data obtained by correcting the original image data by using the PC 6 or the like, there is generated correction image data in which the correction content and the correction position for the printed sheet are adjusted. Therefore, as compared to a conventional technology that reads a printed sheet and inputs a correction content during correction printing, it is possible to greatly reduce a correction time when there are a plurality of corrected images, since it is sufficient to change the original image data.

Further, since the correction image data is generated on the basis of the read image data obtained by reading the shape of the printed sheet with the reading device 3, the accuracy of the correction position can be increased even when the shape of each sheet varies, or when the sheet shape is changed by post-processing after the first printing.

Further, the order in which the corrected image data is inputted may be different from the order in which the printed sheet is set in the sheet device 2. In this case, in accordance with the printed sheet fed from the sheet device 2, correction image data in which the correction content and the correction position are automatically adjusted is generated, and correction printing is performed on the printed sheet. Therefore, it is not necessary for the operator to check the read image data one by one and adjust the correction content and the correction position, increasing the efficiency of the correction printing.

[Modifications]

Note that a configuration may be employed in which the sheet device 2 and the reading device 3 are removed from the image forming system 1. In this case, the image forming apparatus 4 includes a printed sheet reader provided on an upper side of the conveyance path before the image former 30. The printed sheet reader generates read image data by reading an upper surface (front surface) of a corrected sheet when the corrected sheet set in the sheet feeding tray 20 is fed from the sheet feeding tray 20 and conveyed to before the image former 30. Here, if it is necessary to perform correction printing on a back surface of the printed sheet, the printed sheet is reversed by the inverter 23 and then conveyed to before the image former 30 by the reverse conveyance path 22, and an upper surface (back surface) of the corrected sheet is read to generate read image data. On the basis of the read image data, the image forming apparatus 4 can generate correction image data according to a shape of the corrected sheet, and perform correction printing on the corrected sheet.

Further, by adding a sheet feeding tray to the reading device 3 provided in the image forming system 1, a printed sheet may be set in the sheet feeding tray. This enables a configuration in which the sheet device 2 is removed from the image forming system 1.

Further, there is a case where correction printing is not performed on the printed sheet that has been divided and cut as shown in FIG. 7 to FIG. 10. In this case, it is not necessary to perform the processing of step S21 of determining whether the discharged sheet is a divided sheet and step S22 of determining whether the discharged sheet is a final sheet of the divided sheet, from the flowchart of FIG. 12.

Further, the correction position extractor 43 may extract a correction position by using a reference position image such as a register mark or a chart formed in a margin of the printed sheet. If post-processing such as cutting is not performed on the printed sheet, the reference position image such as a register mark and a chart formed in the margin of the printed sheet remains. Therefore, the correction position extractor 43 may also use the reference position image formed on the printed sheet before post-processing, to determine a reference coordinate and extract the correction position. Then, the correction image data generator 44 may generate correction image data in accordance with the reference position image.

In addition, the present invention is not limited to the above-described embodiments, and it is needless to say that various other application examples and modifications can be taken without departing from the gist of the present invention described in the claims.

For example, the above-described embodiments are detailed and concrete description of the configuration of the apparatus and the system for easy understanding of the present invention, and are not necessarily limited to that including all the described configurations. Moreover, a part of a configuration of the present embodiment may also be deleted, replaced, or added with another configuration.

Further, control lines and information lines indicate what is considered to be necessary for the description, and do not necessarily indicate all the control lines and the information lines on the product. In practice, it can be considered that almost all the structures are mutually connected.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a correction content extractor that compares original image data of an original image formed on an image-formed recording material, with corrected original image data of the original image that is corrected, and extracts a correction content of the original image;
a correction position extractor that compares the original image data with read image data read from the image-formed recording material, and extracts a correction position of the correction content according to a shape of the image-formed recording material;
a correction image data generator that generates correction image data for forming a correction image in accordance with a shape of the image-formed recording material based on the correction content and the correction position; and
an image former that forms the correction image at the correction position of the image-formed recording material based on the correction image data.

2. The image forming apparatus according to claim 1, wherein
the correction position extractor extracts the correction position as a relative position with respect to a shape of the image-formed recording material.

3. The image forming apparatus according to claim 1, wherein
the correction position extractor extracts the correction position based on a coordinate with an end face of the image-formed recording material as a reference.

4. The image forming apparatus according to claim 1, wherein
the correction position extractor extracts the correction position based on a coordinate with a reference position image formed on the image-formed recording material as a reference.

5. The image forming apparatus according to claim 1, wherein
the correction image data generator generates the correction image data including the correction image in which, in the original image formed on the image-formed recording material, an area other than the correction content in a correction region including the correction content is overwritten by the image former with a same color as a background color of the image-formed recording material.

6. The image forming apparatus according to claim 1, wherein
the image former forms the correction image for each of the image-formed recording material.

7. The image forming apparatus according to claim 1, further comprising:
a reader that reads the image-formed recording material and generates the read image data, the reader being provided in a middle of a conveyance path between a sheet feeder onto which the image-formed recording material is fed and the image former, wherein
after the image-formed recording material is read by the reader, and the correction image data generator generates the correction image data, the image-formed recording material is conveyed to the image former and formed with the correction image by the image former based on the correction image data.

8. The image forming apparatus according to claim 1, further comprising: a correction execution determiner that determines whether or not to permit formation of the correction image on the image-formed recording material, wherein
when the original image data and the read image data are same, the correction execution determiner determines to permit formation of the correction image and causes the image former to form the correction image, and when the original image data and the read image data are different, the correction execution determiner determines not to permit formation of the correction image and causes the image-formed recording material to be discharged.

9. The image forming apparatus according to claim 8, wherein
when the read image data does not include the correction content, the correction execution determiner determines not to permit formation of the correction image and causes the image-formed recording material to be discharged.

10. The image forming apparatus according to claim 8, wherein
when the correction content is not included in the read image data generated by the reader reading the image-formed recording material that has been divided, the correction execution determiner determines not to permit formation of the correction image and causes the image-formed recording material to be discharged.

11. The image forming apparatus according to claim 8, wherein
in the read image data generated by the reader reading a front surface or a back surface of the image-formed recording material on which the image is formed on both sides based on the original image data, the correction execution determiner determines to permit formation of the correction image on a surface including the correction content and determines not to permit formation of the correction image on a surface not including the correction content.

12. A correction image forming method comprising:
comparing original image data that is an image formed on an image-formed recording material, with corrected original image data obtained by correcting the original image data, and extracting a correction content;
comparing read image data of an image printed on the image-formed recording material with the original image data, and extracting a correction position of the correction content in the image-formed recording material;
generating correction image data based on the correction content and the correction position; and
forming the correction image at the correction position of the image-formed recording material based on the correction image data.

13. An image forming system comprising: an image forming apparatus that forms an image on a recording material; and a reading device that reads the image from an image-formed sheet formed with the image, wherein
the reading device outputs read image data generated by reading an image-formed recording material formed with the image, to the image forming apparatus,
the image forming apparatus comprises:
a correction content extractor that compares original image data that is an image formed on the image-formed recording material, with corrected original image data obtained by correcting the original image data, and extracts a correction content;
a correction position extractor that compares the read image data with the original image data, and extracts a correction position of the correction content in the image-formed recording material;
a correction image data generator that generates correction image data based on the correction content and the correction position; and
an image former that forms the correction image at the correction position of the image-formed recording material based on the correction image data.
